(19) United States
(12) Patent Application Publication
(10) Pub. No.: US 2026/0017594 A1
(43) Pub. Date: Jan. 15, 2026

(54) MULTI-MODAL SOFTWARE ANALYSIS

(71) Applicant: SAP SE, Walldorf (DE)

(72) Inventors: Qi Xu, Shanghai (CN); Shengke He, Shanghai (CN); Tianhao Chen, Shanghai (CN); Eric Stegmueller, St. Leon-Rot (DE); Ting Wang, Shanghai (CN); Wanying Xie, Shanghai (CN)

(73) Assignee: SAP SE, Walldorf (DE)

(21) Appl. No.: 18/769,248

(22) Filed: Jul. 10, 2024

(51) Int. Cl. G06Q 10/0639; G06F 11/34; G06Q 30/0203

(52) U.S. Cl. CPC G06Q 10/06395; G06F 11/3438; G06Q 30/0203

(57) ABSTRACT

The present disclosure provides techniques for improving software development. For software, which can be a user interface or functionality accessed through a user interface, values for both subjective and objective attributes are obtained. Values for subjective attributes can be obtained using techniques such as user surveys. Objective attributes can be automatically captured as a user interacts with a user interface or otherwise during software execution. Objective attributes measure aspects of user interaction with a user interface, such as a number of clicks recorded during an interaction or a duration of the interaction, or information regarding software execution, such as resource use or response time. The values for the subjective and objective attributes are analyzed together, a multi-modal analysis, to obtain a result, such as a clustering result. The clustering result can provide insights into what software issues may exist that are not captured by separately analyzing subjective and objective attributes.

The present disclosure relates to software analysis, such as analyzing software to determine useability or execution problems with the software. Particular implementations relate to gathering information regarding both objective and subjective attributes describing software performance or useability, and then analyzing those attributes together.

### BACKGROUND

Software applications have been fundamental to nearly all aspects of society, from work, to education, to entertainment. Despite the best efforts of programmers and software developers, software can fail to meet users' expectations or have inefficiencies. These inefficiencies can be problematic, both in that they can cause user frustration and lost time, but can also be computationally inefficient. For example, if software involves querying a database, long query execution times or complex query interfaces in a user interface can frustrate a user. However, long query execution time may indicate an issue with how a query is formulated or processed, which can be associated with inefficient use of computer resources such as processors, memory, or network resources.

Developers seek to address these issues in various ways. One way involves soliciting feedback from users regarding their experience using a software application. This feedback can be obtained using techniques such as direct interviews or by providing structured surveys. However, this information can be of limited utility, including because the user feedback may be generic and not tied to particular aspects of the software that might be causing a user to be dissatisfied with the software. A user may be unaware of whether a particular user interface element is a source of frustration or what feature of software may be associated with slow performance.

Another way of seeking to identify and resolve issues with software usability or performance involves the use of objective measures. These measures can include metrics such as a length of time a user interacts with a particular user interface, a number of user interface elements that are used in a session, information about an order in which user interface elements are used, or information about which user interface elements are selected most frequently. Performance metrics can be measured for various operations, such as determining a time taken to receive results if an application requests information in response to user action, such as executing a query or sending a request to retrieve information from a network resource.

The lack of actionable information about sources of user dissatisfaction can make it difficult for software developers to improve software. In some cases, problems may go unaddressed because they cannot be sufficiently identified. Or, software developers may be faced with many possible problems, but may not be able to appropriately prioritize the problems to be addressed, and so resources may be expended on solutions that are of low consequence to users, while more serious problems go unaddressed or take longer to address compared to if more resources had been devoted to solving a problem that might have been more impactful. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure provides techniques for improving software development. For software, which can be a user interface or functionality accessed through a user interface, values for both subjective and objective attributes are obtained. Values for subjective attributes can be obtained using techniques such as user surveys. Objective attributes can be automatically captured as a user interacts with a user interface or otherwise during software execution. Objective attributes measure aspects of user interaction with a user interface, such as a number of clicks recorded during an interaction or a duration of the interaction, or information regarding software execution, such as resource use or response time. The values for the subjective and objective attributes are analyzed together, a multi-modal analysis, to obtain a result, such as a clustering result. The clustering result can provide insights into what software issues may exist that are not captured by separately analyzing subjective and objective attributes.

In one aspect, the present disclosure provides a process of generating a report of how subjective and objective software evaluation attributes contribute to satisfaction or dissatisfaction with software based on a multi-modal analysis. A plurality of sets of evaluation information for a plurality of interaction sessions with software are received. A given set of the plurality of sets of evaluation information includes values for one or more subjective software evaluation attributes and for one or more objective software evaluation attributes.

A multi-modal analysis is performed using the one or more subjective software evaluation attributes and the one or more objective software evaluation attributes for the plurality of sets of evaluation information. The multi-modal analysis classifies given sets of the plurality of sets as being associated with satisfaction with the software or dissatisfaction with the software. This analysis jointly considers the one or more subjective software evaluation attributes and the one or more objective software evaluation attributes to classify given sets of the plurality of sets as being associated with satisfaction with the software or dissatisfaction with the software.

The computing system displays a report. The report indicates how subjective software evaluation attributes of the one or more subjective software evaluation attributes contribute to satisfaction or dissatisfaction with the software and how objective software evaluation attributes of the one or more software evaluation attributes contribute to satisfaction or dissatisfaction with the software.

The present disclosure also includes computing systems and tangible, non-transitory computer readable storage media configure to carry out, or including instructions for carrying out, an above-described method. As described herein, a variety of other features and advantages can be incorporated into the technologies as desired.

### BRIEF DESCRIPTION OF THE DRAWINGS

FIG. 1 is an example user interface screen, having a user interface design that includes a plurality of user interface elements.

FIG. 2 is a block diagram of an example computing environment having a model-view-controller architecture in which disclosed technologies can be implemented.

FIG. 3 is a table illustrating example values that can be captured for user interactions with user interface elements.

FIG. 4 illustrates an example questionnaire that can be used for obtaining data for subjective attributes used in evaluating software.

FIG. 5 provides a table of example clustering results obtained using disclosed techniques.

FIG. 6 is a swimlane diagram of operations performed by a user, a data collector, and a data analyzer in performing a multi-modal analysis.

FIG. 7 is a flowchart of a process of generating a report of how subjective and objective software evaluation attributes contribute to satisfaction or dissatisfaction with software based on a multi-modal analysis.

FIG. 8 is a diagram of an example computing system in which some described embodiments can be implemented.

FIG. 9 is an example cloud computing environment that can be used in conjunction with the technologies described herein.

### DETAILED DESCRIPTION

### Example 1)—Overview

Software applications have been fundamental to nearly all aspects of society, from work, to education, to entertainment. Despite the best efforts of programmers and software developers, software can fail to meet users' expectations or have inefficiencies. These inefficiencies can be problematic, both in that they can cause user frustration and lost time, but can also be computationally inefficient. For example, if software involves querying a database, long query execution times or complex query interfaces in a user interface can frustrate a user. However, long query execution time may indicate an issue with how a query is formulated or processed, which can be associated with inefficient use of computer resources such as processors, memory, or network resources.

Developers seek to address these issues in various ways. One way involves soliciting feedback from users regarding their experience using a software application. This feedback can be obtained using techniques such as direct interviews or by providing structured surveys. However, this information can be of limited utility, including because the user feedback may be generic and not tied to particular aspects of the software that might be causing a user to be dissatisfied with the software. A user may be unaware of whether a particular user interface element is a source of frustration or what feature of software may be associated with slow performance.

Another way of seeking to identify and resolve issues with software usability or performance involves the use of objective measures. These measures can include metrics such as a length of time a user interacts with a particular user interface, a number of user interface elements that are used in a session, information about an order in which user interface elements are used, or information about which user interface elements are selected most frequently. Performance metrics can be measured for various operations, such as determining a time taken to receive results if an application requests information in response to user action, such as executing a query or sending a request to retrieve information from a network resource.

The lack of actionable information about sources of user dissatisfaction can make it difficult for software developers to improve software. In some cases, problems may go unaddressed because they cannot be sufficiently identified. Or, software developers may be faced with many possible problems, but may not be able to appropriately prioritize the problems to be addressed, and so resources may be expended on solutions that are of low consequence to users, while more serious problems go unaddressed or take longer to address compared to if more resources had been devoted to solving a problem that might have been more impactful. Accordingly, room for improvement exists.

The present disclosure provides techniques that enable more effective analysis of software design and operation by jointly analyzing subjective attributes (where the terms attributes, features, measures, and factors can be used interchangeably for purposes of the present disclosure) with objective attributes. Joint analysis, or “multi-modal analysis,” refers to a method where both subjective and objective attributes are analyzed collectively, and their interactions contribute to a particular result. This is distinct from an approach where subjective and objective attributes are both analyzed, but are analyzed separately, without considering their joint contributions/interactions.

For example, a set of attributes that includes both objective and subjective attributes can be defined. Values for the attributes in the set can be obtained. The values, such as in the form of a feature vector, can then be analyzed using various techniques, including clustering and regression, and more sophisticated techniques such as SHAP values or LIME values. In a disclosed technique, the feature vector is assigned to a cluster that represents satisfactory software performance or unsatisfactory performance—this assignment is a result of both subjective and objective attributes.

Clustering can include defining a set that includes both objective and subjective attributes, obtaining values for those attributes, and jointly analyzing those values. Clustering can be used to group similar instances of feature (or attribute) vectors into clusters that represent different levels of satisfaction, such as a dissatisfied cluster or a satisfied cluster. This technique helps identify patterns in the data where similar combinations of objective and subjective attributes lead to satisfaction or dissatisfaction.

Once these clusters are identified, correlations between the attributes within each cluster can be examined. This can help identify which specific objective and subjective attributes are most strongly associated with user satisfaction. For example, certain objective attributes might be consistently associated with high satisfaction in the satisfied cluster, or certain subjective features might be consistently associated with low satisfaction in the dissatisfied cluster.

Regression analysis can be used to quantify relationships between objective and subjective attributes. For example, this information can be used to help understand how changes in objective attributes (like usage patterns) might impact subjective attributes (like user satisfaction). With multiple objective and subjective attributes, regression analysis can help identify which objective attribute features have the most significant impact on each subjective attribute. This analysis can help guide prioritization efforts for improving software.

SHapley Additive explanations (SHAP) values provide a granular understanding of how each attribute contributes to the prediction for each individual instance (feature vector, representing a distinct session/interaction of a user with software, for which values are obtained for both subjective and objective attributes), including considering interactions between attributes, rather than considering them in isolation. In the context of multiple objective and subjective attributes, SHAP values can be used to understand how each attribute contributes to user satisfaction, taking into account complex interactions between attributes. Again, this information can help focus improvement efforts by identifying what attributes might provide the greatest impact if addressed.

Local Interpretable Model-Agnostic Explanations (LIME) values provide local explanations for individual predictions. This can be particularly useful when dealing with complex models where global interpretability is challenging. With multiple objective and subjective attributes, LIME can explain why a model made the predictions it did for specific instances, shedding light on how different attributes interact and influence the outcome at a local level. While LIME is primarily a local interpretability method, the insights gained from these local explanations can be aggregated to discern global trends. By examining the LIME explanations across a range of instances, commonalities and trends can be identified. For example, if a certain attribute consistently has a strong influence on the outcome for many instances, this could suggest a global trend. Similarly, if a certain interaction between attributes frequently appears in LIME explanations, this could indicate a significant interaction in the model overall. In this way, LIME can provide valuable insights that complement those obtained from more global techniques like regression analysis.

### Example 2)—Example Subjective and Objective Software Evaluation Features

As discussed in Example 1, disclosed techniques analyze values for both objective and subjective attributes to identify software features or functionality to be improved. While a variety of different aspects of software can be evaluated, two general categories that can be evaluated include user interface (UI) design and software functionality.

Subjective attributes used to evaluate user interface design include aesthetic appeal, usability, consistency, and accessibility. Aesthetic appeal can include elements that contribute to visual attractiveness and user engagement with a UI. Specific elements that contribute to aesthetic appeal, and which can be evaluated using subjective attributes, include color schemes, typography, iconography, layout, and overall visual coherence. Aesthetic appeal helps create a positive first impression, establish brand identity, and enhance user satisfaction.

Color schemes are chosen to evoke specific emotions or associations and are often selected to be harmonious and visually pleasing. When assessing color schemes for aesthetic appeal, users may be prompted to evaluate, such as with a rating (which can be a numerical rating that is associated with a level of satisfaction) the overall harmony and coherence of the colors used in a user interface, considering how well they complement each other. Additionally, users may be asked to assess the consistency of color usage throughout the interface to ensure a unified visual experience.

Evaluating color contrast between foreground and background elements, as well as between different UI components, can be assessed, as it can impact readability and accessibility. Users can be asked to provide feedback on the emotional impact of the color scheme, assessing whether it aligns with the intended tone of the interface. Furthermore, users can be asked to evaluate how well the color scheme reflects the brand identity or personality, considering its role in brand recognition and differentiation. Users may consider whether the color scheme enhances or detracts from the clarity of the interface, influencing users' ability to interpret visual information accurately. By gathering user ratings on these aspects, software or product developers can gain insights into the effectiveness of the chosen color scheme and identify areas for improvement.

In addition to evaluating the overall qualities of a user interface, it can also be useful to get information about specific user interface elements, layout sections, etc., which may provide more actionable insights. For example, when evaluating the aesthetic appeal of buttons or icons, users can be asked to rate aspects such as color choice, size, shape, and visual clarity. This feedback can help identify specific elements that users find visually appealing or distracting.

Similarly, when assessing the layout and typography of text elements, users may be prompted to provide feedback on readability, font choice, font size, spacing, and alignment. Typography helps shape the visual presentation and readability of text elements within a UI. When assessing typography for aesthetic appeal, users can be prompted to evaluate several key aspects. Users may rate the readability of fonts, considering factors such as font choice, size, spacing, and line height. Additionally, users may assess the visual hierarchy created through typography, evaluating the use of font styles, weights, and colors to differentiate between headings, body text, and other content.

In addition to the overall evaluation, users can provide feedback on specific granular aspects of typography. For example, they may rate the consistency of font usage throughout the interface, ensuring a cohesive visual experience and facilitating easy comprehension of textual information. Users can also assess the appropriateness of font choices for different interface elements, such as headings, body text, and labels, to ensure visual clarity and effectiveness in conveying information.

Feedback on typography legibility, contrast, and adaptability to different screen sizes and resolutions can help ensure that textual content is accessible to all users, including those with visual impairments or reading disabilities. Additionally, users may provide feedback on the emotional impact of typography, assessing whether it aligns with the intended tone of the interface and enhances user engagement.

The visual presentation of images or graphics within the UI also contributes to the overall aesthetic appeal and user engagement. When assessing the visual presentation of images or graphics for aesthetic appeal, users may be prompted to evaluate aspects such as the overall quality and relevance of images or graphics, considering factors such as clarity, resolution, and appropriateness for the interface context. Additionally, users can assess the visual impact and consistency of images or graphics across different sections or screens of the UI, ensuring a cohesive visual experience.

In addition to the overall evaluation, users can provide feedback on specific granular aspects of the visual presentation of images or graphics. For example, they can be asked to rate the alignment and placement of images or graphics within the interface, providing feedback on visual balance and harmony. Users can also assess the relevance of images or graphics to the surrounding content and their effectiveness in conveying information or enhancing user engagement.

Feedback on image or graphic legibility, contrast, and adaptability to different screen sizes and resolutions can help ensure that visual content is accessible to all users, including those with visual impairments or color vision deficiencies. Additionally, users may provide feedback on the emotional impact of images or graphics, assessing whether they align with the intended tone of the interface and evoke the desired user response.

Iconography uses graphical symbols to represent actions, features, or concepts within the interface, requiring clarity and recognizability. When assessing iconography for aesthetic appeal, users may be prompted to evaluate the overall clarity and recognizability of icons, considering factors such as shape, color, and symbolism. Additionally, users may assess the consistency and coherence of icon styles across different parts of the UI, providing feedback as to whether the UI provides a unified visual experience.

In addition to the overall evaluation of iconography, users can provide feedback on specific granular aspects. For example, they may rate the appropriateness of icons for representing specific actions or functions within the interface, ensuring alignment with user expectations and conventions. Users can also assess the visual hierarchy and organization of icons within the UI, facilitating easy navigation and understanding. Feedback can be obtained regarding icon legibility, contrast, and adaptability to different screen sizes and resolutions, or on the emotional impact of iconography, assessing whether icons align with the intended tone of the interface and enhance user engagement.

Layout design involves organizing UI elements in a logical and visually appealing manner to facilitate navigation and information hierarchy. Consistency across screens or modules ensures a cohesive user experience, while creativity and innovation can differentiate the interface from competitors. Assessing layout design for aesthetic appeal can include obtaining subjective ratings of the overall organization and visual coherence of the layout, which can include factors such as alignment, spacing, and balance. Additionally, users may assess the consistency of layout styles across different screens or modules, which can help assess whether the UI provides a cohesive visual experience.

In addition to the overall evaluation, users can provide feedback on specific granular aspects of layout design, such as the effectiveness of layout grids or patterns in guiding user attention and interaction. Users can also assess the appropriateness of layout structures for presenting different types of content or functionalities, providing insights as to whether the UI provides intuitive navigation and task completion. Feedback on layout clarity, hierarchy, and flexibility can help ensure that UI elements are organized in a way that facilitates easy comprehension and adaptation to user needs, or whether the layout aligns with the intended tone of the interface and enhances user engagement.

Moving from aesthetics to useability, usability evaluation can include soliciting feedback regarding the ease of navigation, intuitiveness of controls, clarity of labels and instructions, and overall user-friendliness of the UI. These factors contribute to users being able to interact with the UI effectively and accomplish their tasks efficiently.

In an overall evaluation of a UI, users can rate the overall ease of navigation, considering attributes such as the intuitiveness of menu structures, the clarity of navigation paths, and the efficiency of accessing desired features or content. Users can provide feedback on the intuitiveness of controls, such as evaluating the ease of locating and using interactive elements such as buttons, links, and menus. Additionally, users may provide feedback on the clarity of labels and instructions throughout the interface, which provide information about whether textual cues and guidance are easy to understand and follow. Users can rate the overall user-friendliness of the UI, considering their overall satisfaction with the interface's usability.

Looking at useability at a more granular level, users can provide feedback on specific aspects such as menu organization, breadcrumb trails, search functionality, and the presence of navigation aids like back buttons or home links for navigation. When evaluating controls, users may assess the intuitiveness of button placement, the responsiveness of interactive elements, and the consistency of control behaviors across different sections of the UI. Feedback on labels and instructions can provide a subjective evaluation of the clarity of terminology, the conciseness of instructions, and the consistency of labeling conventions used throughout the interface. Users can provide granular feedback on specific usability challenges they encountered, such as difficulties in completing tasks, confusion with interface elements, or frustrations with error messages or feedback mechanisms.

Various techniques can be used to obtain subjective information that reduce variability in subjective data, or provide more standardized ways of capturing subjective data. The System Usability Scale (SUS) is one example, where a standardized questionnaire is provided to evaluate overall usability. SUS scores can be calculated based on user responses to a series of Likert-scale questions.

A variety of objective attributes can be used to evaluate various aspects of a user interface. For example, various response times can be measured, such as the time it takes for the UI to respond to user inputs, including clicks, taps, or keystrokes. Response time can be measured in time units using performance monitoring tools. Performance attributes can also include loading times, such as measuring the time it takes for the UI to load content or features, including text, images, scripts, and stylesheets. Loading time is typically measured from the initiation of a request to the complete rendering of the content and, in certain cases, can be analyzed using network performance tools or browser developer tools. For other types of UIs, measurements can be performed using integrated development environments (IDEs) used for UI development, or using software development kits (SDKs) or other development tools.

Computer resource use can also be monitored, such as the use of CPU, memory, or network resources by the UI during interactions. High resource usage can indicate performance bottlenecks or inefficiencies within the UI, which can degrade a user's experience.

Certain aesthetic aspects of a UI can be measured objectively. For example, color contrast ratios can be determined, where a result can indicate whether there is sufficient contrast between text and background colors for readability.

Objective attributes can evaluate how effectively users are able to interact with a UI, such as in inputting data or selecting UI elements to perform a task. User error rates can count a number or frequency of errors made by users, such as input errors, validation errors, or errors resulting from incorrect use of UI elements. User error rates can be tracked and logged during user testing sessions or through analytics platforms integrated into the UI. Information about the duration of user sessions can also provide information about the effectiveness of a UI. For example, overly short session times can indicate that users have become frustrated and given up on a task, while overly long session times can reflect that a user has persevered, but has had difficulty performing the task.

Information about task completion by users can serve as objective attributes, such as by measuring task completion rates or a time taken to complete a task. For example, task completion can measure the proportion of users who accomplish intended tasks within the UI, such as completing a purchase, filling out a form, or navigating to a specific page. Task completion rates are calculated based on user interactions and can be analyzed using user testing sessions or analytics data. Temporal information can include measuring statistical metrics related to task completion, such an average time taken by users to complete tasks within the UI.

Interaction metrics can be used as source of information to measure how users interact with a UI. For example, click frequency counts the number of times UI elements are clicked by users during interactions. Clicking the same UI element multiple times can indicate that a user is having difficulty performing a task using the UI. Click sequences track the order in which UI elements are clicked during user interactions, which can identify common user pathways and navigation patterns. In some cases, actual user click sequences can be compared with a defined click sequence that reflects expected/intended behavior. A total number of clicks or actions in a single user session can also be tracked.

The UI may be associated with software errors. System error rates can measure the occurrence of technical errors or bugs within the UI. Types of errors can include server errors, database errors, or client-side errors. System error rates can be monitored using error tracking tools or logging frameworks that capture and report errors.

The evaluation of software functionality differs from evaluating an associated user interface (UI). For example, a UI may be effective or ineffective in enabling users to perform various functions, but that is separate from whether or not functions that are triggered through the user interface perform well, whether evaluated using subjective or objective attributes.

Consider video editing software as an example. The UI evaluation can include analyzing the layout, design, and usability of the editing interface, such as the placement of editing tools, the clarity of labels, and the intuitiveness of controls. Functionality evaluation can evaluate functionality such as timeline editing, special effects application, and export options. A user may be able to access timeline editing easily in the user interface, but may be dissatisfied with the editing results or the time taken for editing actions to be executed once a user interface element is selected, or the UI may be responsive, but it may take a long time for editing results to be returned or computing processes associated with editing may be inefficient.

For software functionality, users' satisfaction levels may be influenced by attributes such as the reliability and accuracy of outcomes, the alignment of features with users' needs and expectations, and the software's responsiveness and adaptability to different usage scenarios. Users may express satisfaction if they find the software's functionalities intuitive, efficient, and capable of meeting their objectives effectively. User satisfaction with software functionality can be influenced by the reliability and consistency of results, as well as the software's responsiveness and performance in executing tasks.

In addition to the evaluation of how specific functionalities perform, users can provide feedback as to whether the software meets their expectations in terms of the range and depth of functionality offered. Users may evaluate whether the software has a full set of core features for fulfilling primary user tasks, as well as additional capabilities that enhance the overall user experience.

In addition to evaluating whether functionality is implemented well, and is complete, users can provide feedback as to whether software functionality is sufficiently flexible and customizable/configurable. Users may evaluate the availability of customization options, configuration settings, and personalization features that allow them to tailor the software to their preferences. User satisfaction with flexibility and customization may be influenced by attributes such as the variety and depth of customization options available, the ease of configuring settings, and the degree of control afforded to users over the software's behavior and appearance.

As with the UI, software functionality can be evaluated using objective attributes as well as subjective attributes. Performance metrics for this purpose can measure the software's responsiveness, efficiency, and reliability in executing tasks and processing data, including under different use scenarios and workload conditions.

Response time measures the duration between a user input or request and the corresponding system response. Unlike UI responsiveness, which focuses on the speed and fluidity of UI interactions, response time encompasses the entire processing pipeline within the software, including backend processing, data retrieval, and system-level operations. Loading time measures the time it takes for the software to load content, features, or components upon initialization or user request, which can reflect efficiency in accessing and retrieving data from storage or external sources.

System resource usage metrics monitor the use of computing resources such as CPU, memory, disk, and network resources by the software during operation. These attributes provide insights into the software's resource consumption patterns and can help identify potential bottlenecks or inefficiencies in resource utilization.

Throughput measures the rate at which the software processes tasks or transactions within a given time period. This attribute quantifies the software's processing capacity and efficiency in handling concurrent user requests or workload spikes. Similarly, scalability attributes assess the software's ability to maintain performance levels as the workload or user base increases.

The objective performance attributes are typically obtained through techniques such as performance profiling, benchmarking, and load testing. Performance profiling involves adding functionality to the software to collect performance data during execution, such as response times, resource usage, and throughput. Benchmarking compares the software's performance against predefined criteria or industry standards to identify areas for improvement. Load testing simulates real-world usage scenarios to assess the software's performance under different levels of user activity or workload.

Accuracy and reliability in software accessed via the user interface (UI) can also be characterized using objective attributes, such as assessing the correctness of computational results, the precision of data retrieval, and the robustness of error handling mechanisms. This evaluation focuses on the software's ability to consistently deliver accurate and reliable outcomes, independent of the UI's design or performance.

Accuracy refers to the degree of correctness or precision in the software's outputs or outcomes. It measures the extent to which the software's computational results align with expected or desired outcomes. For example, in a financial application, accuracy may be evaluated based on the correctness of calculations, such as interest accruals or investment returns, performed by the software.

Reliability describes the software's consistency and dependability in delivering accurate outcomes over time and under varying conditions, such as across different use scenarios and workload conditions, without unexpected failures or errors. Reliability attributes may include measures of system uptime, error rates, and failure rates.

Accuracy and reliability can include conducting functional testing to validate computational algorithms and processing logic, as well as performing regression testing to ensure that software updates or modifications do not introduce errors or deviations from expected behavior. Additionally, software may be subjected to stress testing and fault tolerance analysis to evaluate its performance under extreme conditions or in the presence of faults or failures.

Software interoperability can be investigated using objective attributes. Interoperability includes the ability of the software to integrate with other systems, platforms, or data sources, independent of the user interface (UI). Interoperability evaluation can test the software's compatibility with external systems, adherence to industry standards, or ability to exchange data or communicate effectively with other software components.

Compatibility testing can include verifying that the software can coexist and operate effectively alongside other systems, platforms, or technologies within its environment. Adherence to industry standards is another aspect that can be evaluated, as the software might be intended to use common protocols, formats, or interfaces that facilitate communication and data exchange between different software systems.

### Example 3)—Example User Interface Screen

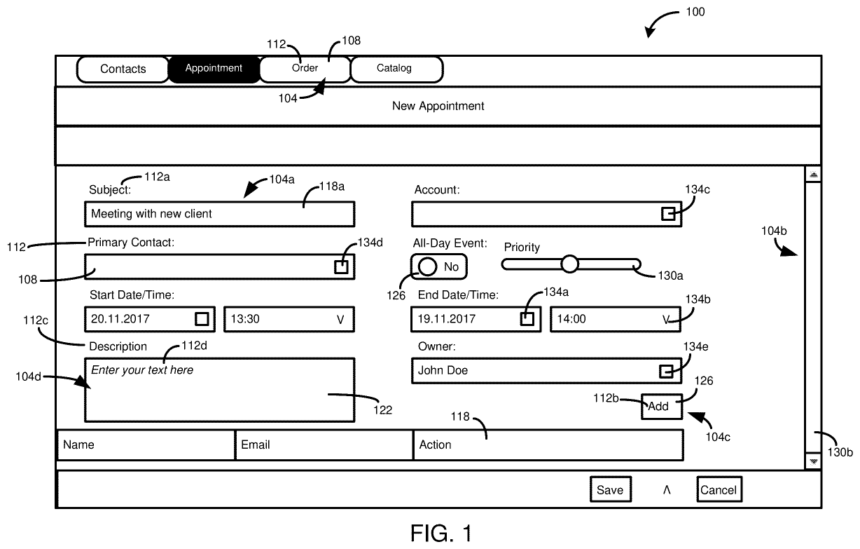

FIG. 1 illustrates an example user interface screen 100. Although the disclosed technologies are not limited to any particular user interface, or even particular user interface elements, FIG. 1 includes a plurality of user interface elements 104, all or a portion of which can be tracked and used to determine possible user interface design issues or issues with software that implements functionalities to which the user interface provides access. Other user interface designs, and user interface element types, can be associated with obtaining values for objective attributes in an analogous manner as will be described for the screen 100. The various user interface elements of the user interface screen 100, as well as the overall user interface screen, can also be evaluated by users for various subjective attributes.

The user interface elements 104 can include one or more control portions 108. The control portions 108 can be displayed elements that can be activated or edited by a user. For example, a control portion 108 can be a text box, text field, button, scroll bar, slider, etc. User interface elements 104 can optionally be associated with one or more labels 112. Labels 112 may or may not be selectable by a user, but typically provide context for a control portion. For example, user interface element 104a is a text field that is associated with the label 112a of “subject.” Thus, the label 112a guides a user as to what input is expected in the text field.

In some cases, a user interface element 104 need not have a label 112. For example, the scroll bar element 104b does not have a label. The graphical representation of button element 104c includes text corresponding to a label 112b, but does not include a separate label. Text box element 104d includes a label 112c next to the text box, and includes additional text, which can serve as a label 112d (e.g., additional text can be part of the text box element 104d, rather than being a separate label). In at least some cases, labels 112 can be specified code that is used in rendering the corresponding user interface elements 104.

The user interface screen 100 can relate to a particular workflow. As illustrated, the workflow can relate to scheduling an appointment, such as an appointment with a client. The user interface elements 104 can represent various components that can be used in setting various aspects of the appointment. The information regarding the appointment can be stored in a data object, such as an instance of an abstract or composite data type, or in a table, such as a relational database table.

The user interface screen 100 can include a plurality of text fields 118 and text boxes 122. For example, text field 118a can allow a user to type a note in the subject field, describing an appointment. Text box 122 can allow a user to enter additional information regarding an appointment.

The user interface screen 100 can include a plurality of buttons 126. Buttons 126 can allow a user to select between one or more options or values. For example, a button can be pressed to cause a particular action to be taken, such as to save an appointment. Other buttons 126 can correspond to binary switches indicating selected/not selected, or otherwise selecting between two values. Other buttons 126 can be activated to select between more than two values, such as a button representing days of the week, where successive selections cycle through the days.

The user interface screen 100 can include variable value controls 130, such as a slider 130a and a scroll bar 130b. The variable value controls 130 can allow a user to select a value within a, typically bounded, range.

A plurality of picker elements 134 can be included, including a date picker 134a, a time picker 134b, an account picker 134c, a contact picker 134d, and an owner picker 134e. In some cases, such as the date picker 134a and the time picker 134b, selection of the picker element can cause standard selection functionality to be called. A file picker can be implemented in a similar manner, where selecting the file picker causes a file browser functionality to be implemented. In other cases, a picker element 134 can be linked to specific menu choices for the picker element, which can be preset options, or options that are drawn from a data source, such as a database (e.g., from a list of contacts associated with a particular user or account).

Typically, a user interface screen will be designed to facilitate a particular task that is designed to be carried out using the screen. For example, the user interface elements are typically arranged on the screen, including their location on the screen, location relative to other user interface elements, size, color, etc., to guide a user through a workflow. That is, rather than being displayed in a haphazard manner, the user interface elements are placed to guide a user through a task, corresponding with the user's mental process in accomplishing the task.

Taking the screen 100 as an example, it might be expected that a user would first want to enter a subject for an appointment, then enter a contact for the appointment, and then enter information regarding the time and location of the event. However, different users may think about a task in a different way. In addition, different users may more intuitively associate some terms with task components than other terms. Thus, a user interface designed for one user may not be as suitable for another user. Differences in language, nationality, technical expertise, job function, and similar criteria can result in certain user interface designs being very good for some users, but poor for others. In particular, a user interface designer may think about a task very differently from an end user. Changes to particular user interface elements, such as sizes, placements, labels, etc., can thus make a user interface more or less usable for various groups of users.

At least a portion of user interface elements of a user interface can be associated with tracking elements. A tracking element can cause an entry to be generated, such as in a log, which can include information that can be used to evaluate the effectiveness or performance of a user interface design. Tracking elements can be implemented in different ways in order to generate a “click stream.” In a particular example, code defining a user interface element can be configured to cause a log entry to be written when the user interface element is selected or interacted with. For example, code implementing actions to be taken on a button selection (e.g., triggered in response to an event listener) can include functionality to change a variable, but also code to write a log entry. The tracking functionality can be selectively activatable, at least in some aspects. For example, the tracking functionality may only execute if a flag is set to true (e.g., “If Reporting Flag==True, WriteLogEntry (controlId, time, date)”).

The log entries produced by the tracking elements can help determine if a user interface is functioning efficiently, in general, or for a particular user. In some cases, based on an analysis of the log entries, such as using a disclosed technique that combines these types of objective attributes with subjective evaluation attributes, it can be determined that one or more elements of the user interface should be altered. For example, it could be that a text label is non-intuitive. In the example of FIG. 1, it could be that the label 112c, “Description,” for the text box 122 is not sufficiently descriptive, and that users pause for a significant amount of time before entering text in the text box. The tracking information can reveal this delay, and the developer can potentially resolve the problem by using a different label 112. Issues related to user interface element size and position can be identified and altered in a similar manner.

In other cases, it can be determined that a particular user is having an unexpected problem with the user interface. It may be that the user interface is well suited to the vast majority of users, but a particular user, for whatever reason, is having difficulty navigating the user interface.

The disclosed technologies are not limited to any particular user interface or user interface elements. General categories of user interface elements that can be used with the disclosed technologies include input controls, navigational controls, informational elements, and containers. Input controls can include user interface elements such as check boxes, radio buttons, list boxes, drop down lists, buttons, dropdown buttons, text fields, text boxes, toggles, and pickers, such as date pickers, time pickers, file browsers, and the like. Navigational controls can include user interface elements such as breadcrumbs, search fields, tags, pagination elements, icons, sliders, or image carousels. Information elements can include progress bars, notifications, tool tips, message boxes, and pop ups. Containers can include accordion elements.

User interface elements can be associated with different types of user interactions. In at least some aspects, a single user interface element can be associated with a plurality of user interaction types. In other aspects, a user interface element can be associated with a single user interaction type. User interaction types can include button presses, changes, and live changes. Button presses can represent a selection or activation of a user interface element. A change event can represent a change in a value, such as a slider, text field, or text box that is formally set by a user. Being formally set by a user can include a user hitting an enter key or taking similar action to indicate that their input is complete, at least for a present interaction (e.g., the user may change the value later). Being formally set can also include user activity making the user interface element go out of focus. For example, if a user enters text in a first text field, and then clicks in a second text field, the activity in the first text field can be recorded as a change.

Live changes can represent a continuous or potentially transitory interaction with a user interface element. For example, typing or copying or pasting text into a text box or text field can be recorded as a live change. Similarly, user activity changing the value of a slider or a scroll bar can be recorded as a live change. Live changes, in at least some cases, can precede change events. That is, for example, a user typing in a text field can be recorded as a series of live changes (in some cases, a live change can be recorded for each key stroke). Once the user hits enter, or the user interface element goes out of focus, a change event for the user interface element can be recorded.

### Example 4—Example Tracking of User Interface Interactions

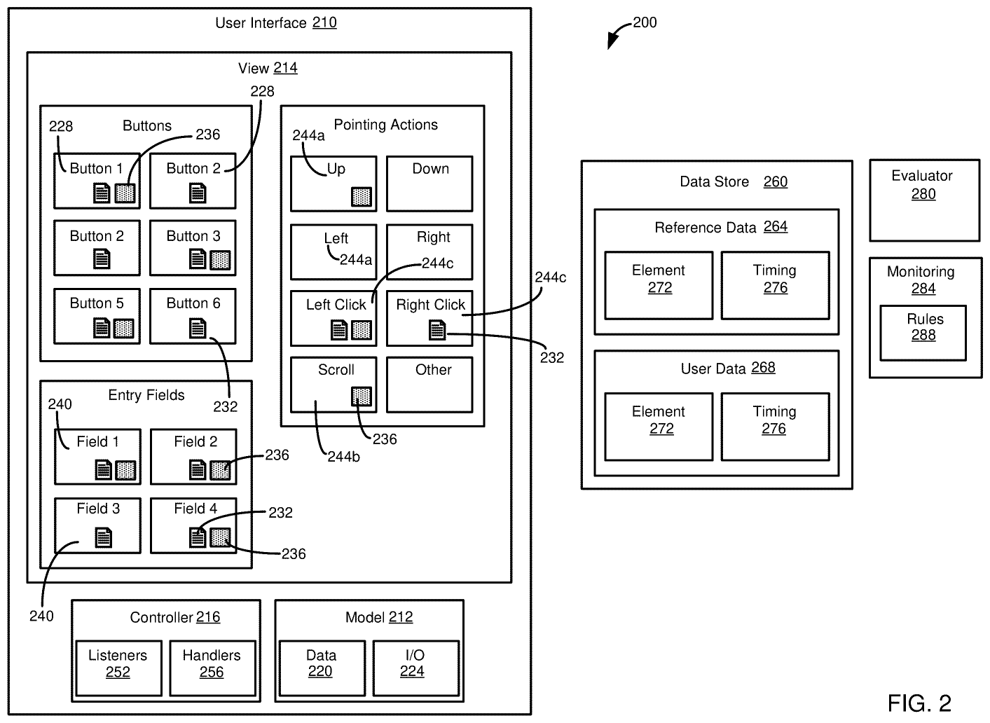

FIG. 2 illustrates an example computing environment 200 in which disclosed technologies can be implemented. The computing environment 200 includes a user interface 210. The user interface 210 can be based on a model-view-controller design, including a model 212, a view 214, and a controller 216.

The model 212 can include data that is to be rendered by the view 214, and with which a user can interact using the controller 216. The model 212 can include data 220. The data 220 can represent, for example, data from a database, and can include data entered by a user. The model 212 can include an input/output component 224 that can retrieve and store data 220. For example, in response to input received through the controller 216, the input/output component 224 can retrieve data 220 associated with a selected file. The data 220 can then be rendered for display in accordance with the view 214.

The view 214 can define how data 220 in the model 212 should be rendered. The view 214 can also define functionality for causing actions to be taken regarding the data 220. The view 214 can define various user interface elements, including user interface elements that can be associated with tracking functionality. The user interface elements can include one or more buttons 228. The buttons 228 can be associated with metadata 232. The metadata 232 can define aspects of how the buttons 228 are displayed, such as including a text label to be displayed on or proximate the button. The metadata 232 can define a type or category for the button 228, and may specify display properties of the button, such as a size, color, location, etc.

One or more of the buttons 228 can be associated with a label or tag 236 that can be associated with tracking information. The label or tag 236 can include an identifier of the button 228, and context information associated with the button, such as a workflow with which the button is identified, or a user interface identifier for the user view 214 (e.g., a particular page, view, or screen of the user interface 210). However, the label or tag 236 can include more, less, or different information. For example, the label or tag 236 can simply indicate that a user interface element was activated, along with sequence information, which can be one or both of an identifier of an order in which the user interface element was activated and a time at which the user interface element was activated or interacted with.

The view 214 can include other types of user interface elements, such as entry fields (e.g., text fields or text boxes) 240. As with the buttons 228, the entry fields 240 can include metadata 232, which may be similar to the metadata of the buttons. At least a portion of the entry fields 240 can include labels or tags 236, which can be similar to the labels or tags of the buttons 228.

Pointing actions 244 are another type of user interface element that can be included in the view 214. Pointing actions 244 can include actions 244a that move a cursor, or pointer, in various directions. Pointing actions 244 can also include scrolling actions 244b and selection actions 244c, such as “right click” or “left click” actions. One or more of the pointing actions 244 can include one or both of metadata 232 and labels or tags 236, which can be similar to the metadata 232 and the labels or tags 236 of the buttons 228. However, in at least some cases, the metadata 232 or tags 236 can include different information than the metadata or labels or tags 236 of the buttons 228.

That is, in at least some cases, pointing actions 244 can be comparatively generic user interface elements, rather than being specific to a particular user interface 210 (e.g., a button 228 may relate to a specific action for a specific user interface, whereas pointing interactions are a generic interaction for a computing device—there is no special significance to “up” in one user interface versus another). However, pointing actions 244 can still provide information about a specific user interface 210. For example, the position of a cursor on a display, or the type of pointing actions 244 being made by a user, can indicate whether a user is “looking” for a user interface element in a particular area of the screen, or can indicate a possible source of confusion of the user (e.g., periods of time between the selection of buttons 228 or other user interface elements may be associated with different design issues depending on whether the user is taking no action at all during the time period or is engaging in pointing actions 244).

In some aspects, pointing actions 244 and other user interface elements can be combined to provide user interaction information. For example, a user interface 210 may have specific menu options that are brought up on a “right click,” and which are then selected using a “left click.” Or, a user interface element, such as a menu or a button 228, is selected based on user pointing actions 244 (e.g., the user “left clicks” on a button). Distinguishing how a user activated a user interface element, such as a button 228 or a menu item, such as by a pointing action 244 versus a keyboard shortcut, can be useful, in some circumstances.

Although the view 214 is shown with particular types of user interface elements (e.g., buttons 228, entry fields 240), it should be appreciated that the view can include more, fewer, or different types of user interface elements than shown in FIG. 2, and different numbers of such user interface elements. All or a portion of any particular type of user interface element can be associated with one or both of the metadata 232 and labels or tags 236. In addition, although FIG. 2 illustrates a model-view-controller design, tracking functionality, which can include the use of the metadata 232 or tags 236, can be used with other types of user interface implementations.

The controller 216 can include listeners (e.g., event listeners) 252 and handlers (e.g., event handlers) 256. Listeners 252 can determine when a particular user interface element, such as an element of the view 214, is triggered or activated by a user. The handlers 256 can define actions that are taken when a listener 252 determines that a particular user interface element has been activated. In particular aspects, tracking functionality can be incorporated into the handlers 256 (or, in some cases, into the listeners). For example, although shown as part of the view 214, the metadata 232 or tags 236 can be implemented in the controller 216, such as in the handlers 256.

The computing environment 200 can include a data store 260. The data store 260 can store reference data 264 and use, or test, data 268. The reference data 264 and user data 268 can include element information 272 and timing information 276. The element information 272 can include information regarding particular user interface elements that were activated, while the timing information 276 describes when, or in what sequence, the user interface elements were activated.

The reference data 264 can be used to establish user interactions, and interaction patterns, that are “normal,” or indicative of acceptable user interface design, and interactions, and interaction patterns, that are “abnormal,” or indicative of user interface design issues, or that a particular user is having issues with a particular user interface. The reference data 264 can be used to establish criteria as to whether user data 268 indicate expected/desired behavior or unexpected/undesired behavior, which can be used by an evaluator 280. The user data 268 can be submitted to the evaluator 280, along with values for subjective attributes for a UI or software functionality accesses using the UI.

### Example 5—Example Record of User Interface Interactions

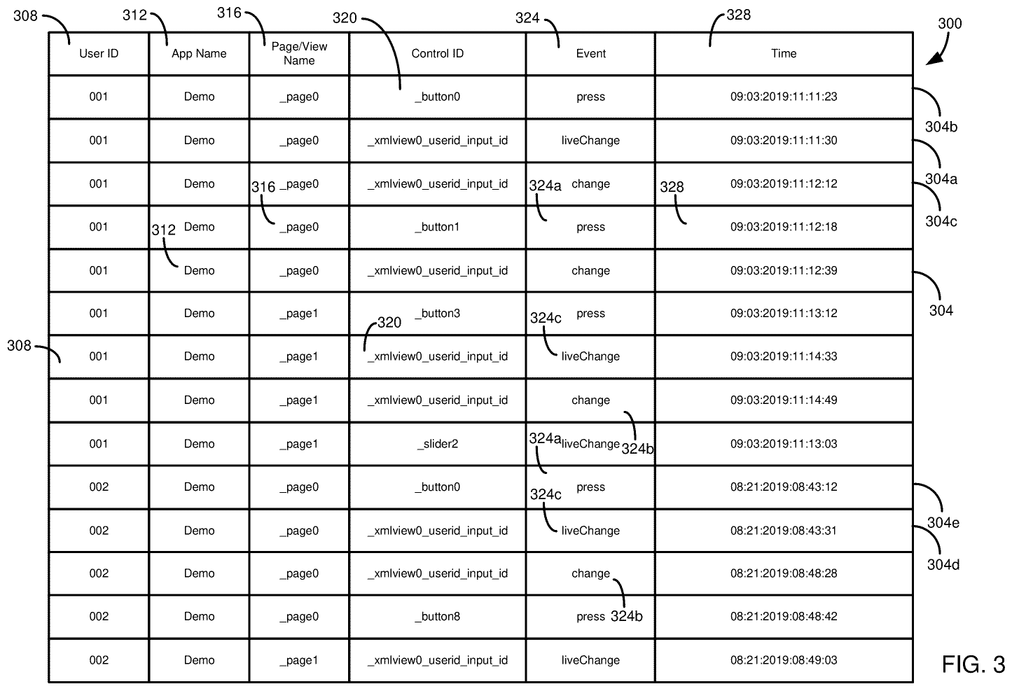

FIG. 3 illustrates a table 300 that can represent a log produced by monitoring user activities, such as monitoring occurring in conjunction with the computing environment 200 of FIG. 2. The table 300 can include a plurality of entries 304. The entries 304 can include information regarding particular user interactions with particular user interface elements of a particular user interface, including particular screens, pages, or views.

As shown, each entry 304 includes a user identifier 308. The user identifier 308 can be, for example, an alphabetical, numeric, or alphanumeric identifier of a particular user. The user identifier 308 can be a name of a user, or otherwise used to distinguish individual users. In some cases, the identity of a user does not matter, other than to distinguish one series of user interface interactions from another series of user interface interactions.

The entries 304 can include information that identifies a particular context for a user interaction. The context can include an application name, or identifier, 312, and a page, view, or screen name, or identifier, 316. The identifiers 312, 316 can facilitate techniques for evaluating a user interface or its associated software functionality. For example, the identifiers 312, 316 can help ensure that training data is more accurate, in that different applications, and even different screens of the same application, can have different functions, different user interface elements, or different displays of user interface elements. Accordingly, one particular screen may not be comparable with other screens. Or, screens that are sufficiently similar, in some cases, can be grouped for comparison purposes, where the identifiers 312, 316 can be used in defining groups and determining group membership. The identifiers 312, 316 can also be used for reporting purposes, such as to guide a developer to which application, or screen thereof, may be associated with design issues.

The entries 304 can include an identifier 320 of a particular user interface element or a particular interaction type (e.g., cursor movement, cursor selection, typing, swipe, pinch and zoom, etc.). In some cases, the identifier 320 can be used to help determine whether a particular user interface interaction sequence is abnormal, or to establish a baseline of normal interaction. For example, the identifiers 320 can facilitate comparisons between different user interaction sequences, where a user may choose to interact with user interface elements in different orders. The identifiers 320 can also be used to help guide a developer to particular user interface elements that may be a source of a user interface design issue, or used in correlating particular user interface elements to particular problem types, general solution types, solution implementations, or combinations thereof.

The entries 304 can include an event type 324. The event type 324 can be a particular category of user interaction, such as input, navigation, information, etc. The event type 324 can represent other types of information, such as whether the user input was a button press, a pointing device action, a text entry, etc. As shown in FIG. 3, the event types 324 include button presses 324a, changes 324b, and liveChanges 324c. LiveChanges 324c can represent variable input or potentially transient input, such as user typing actions, where a user may add text or remove text before completing an entry. LiveChanges 324c can also represent interactions with user interface elements such as a slider bar.

Changes 324b can represent final, or at least temporarily final (e.g., the user can return to a field and change a previously entered value), user actions. A user typing text into a text box, for instance, may initially be a liveChange 324c. If a user presses the enter key, or the user interface elements goes out of focus (e.g., the user selects a different user interface element), the interaction can be recorded as a change event 324b.

Each entry 304 can be associated with one or more times 328. The times 328 can be used for at least two purposes. The times 328 can be used to establish an order or sequence in which user interface elements were activated. The order can be used, among other things, to define a workflow or to determine if particular user interactions are out of sequence compared with a baseline.

The times 328 can also be used to establish a time that can be correlated with how long a user takes to complete an action. As an example, event 304a is shown with a time of 11:11:30, while the preceding event 304b is shown with a time of 11:11:23. The difference between these times, 7 seconds, can represent a period of time taken by a user to determine a next action to take and to activate the appropriate user interface element. Event 304a can represent a user typing in a text box or text field, while event 304c can represent the user pressing the enter key or the text box or text field going out of focus. The time taken to complete the text entry, 42 seconds, can provide an indication of whether the user understood the information that was required to be entered.

User interaction durations or delays determined from the times 328 can be used for a variety of purposes. For example, the 7 seconds taken to move from event 304b to 304a can be compared with a threshold or range. If a normal time to move to a text box is less than 10 seconds, then the event sequence of table 300 can be determined to be normal or acceptable. On the other hand, if the normal time taken to move to a text box is less than 5 seconds, then the 7 second time can indicate the presence of a user interface design issue. That is, it may be possible to reduce the interaction time by providing a more understandable label for the text box, making the text box larger, moving the text box to another location, highlighting the text box, etc.

The interaction durations or delays determined from the times 328 can also be used to determine whether a particular user is having unexpected issues with a user interface design. Events 304d, 304e represent the same interaction sequence as events 304a, 304b. However, while user 1 completed the transition in 7 seconds, user 2 took over two minutes. While user 1 took 42 seconds to complete the text entry, user 2 took over 2 minutes. In some cases, user 2's interaction times may indicate a problem with the user interface design. In other cases, user 2's interaction times may indicate that user 2, for whatever reason, is having difficulty with the user interface.

### Example 6—Example Survey for Obtaining Subjective Evaluation Data

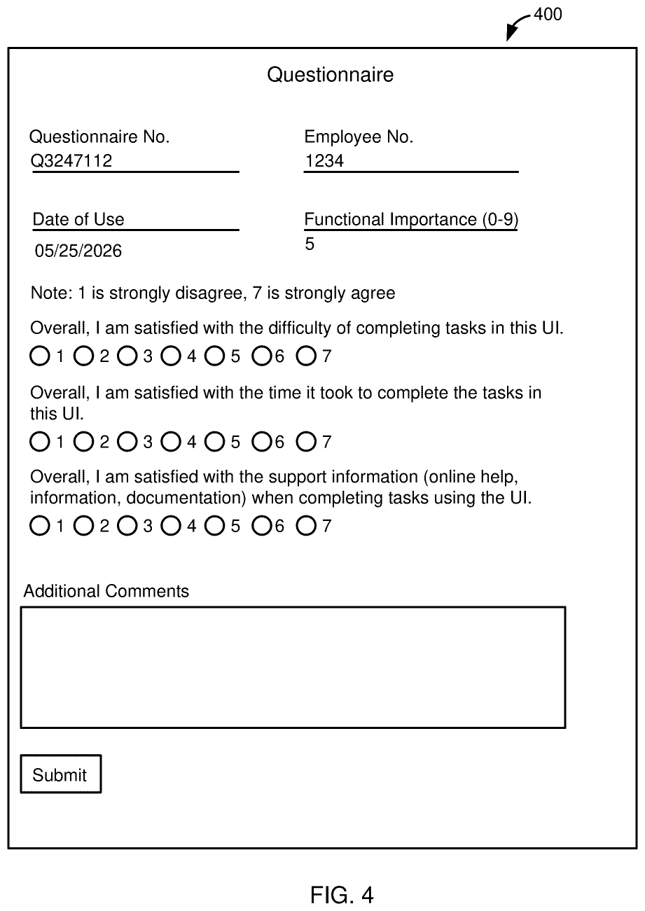

FIG. 4 illustrates an example survey 400 that can be provided to a user to obtain subjective evaluation data for a user interface or other software functionality, such as by displaying the survey on a UI after a user has performed an action using the UI. The responses can be logged and used along with values for objective evaluation criteria in disclosed techniques. As will be further discussed, whether a particular UI, UI element, or software feature is “important” to a user can help in interpreting results of analyzing subjective and objective attributes. Accordingly, user can assign an importance to the functionality being surveyed using a user interface element 410.

A series of questions 420 are presented, where a user can indicate a level of satisfaction by selecting an appropriate UI element. This subjective evaluation of satisfaction can be combined with information about functional importance and values for objective evaluation criteria in disclosed techniques. The values for the subjective attributes obtained using the survey 400 can be stored, such as a database, and associated with values for objective attributes obtained during use of a UI associated with an instance of the survey 400. This information can be collectively processed to provide a multi-modal analysis.

### Example 7—Example Predictions Using Multi-Modal Analysis

Disclosed techniques will be described with respect to a particular use scenario. In the use scenario, a user interface is evaluated using a combination of objective and subjective attributes. Objective attributes include a number of clicks in a user session with the UI, a total time of use during the session. Other types of information can be gathered and evaluated, such as information about how the number of clicks changes over a time, such as if different patterns are observed during days of the week. In the example use scenario, subjective attributes include user-reported functional importance and questionnaire responses as to whether a user is satisfied with the user interface overall or with particular aspects, such as information gathered using the survey 400 of FIG. 4.

In a particular example, unsupervised learning techniques are used to analyze data from records of use of the user interface, where a record includes values for both subjective and objective attributes from a particular user session. In a particular example, clustering, such as K-means clustering, is used to cluster evaluation records, such as where clustering generates two clusters, representing scenarios where the software functionality is associated with satisfaction (or satisfactory performance) and scenarios where the software functionality is associated with dissatisfaction (unsatisfactory performance).

In general, feature vectors can have the form {S₁, S₂, S₃, . . . Sₙ, O₁, O₂, O₃, . . . Oₙ), where the S terms are the subjective evaluation attributes and the O terms are the objective evaluation attributes. For the vector, non-numerical data can be encoded numerically, such as where responses like high, medium, low can be converted to a numerical representation, such as having the value of 3 for high, 2 for medium, and 1 for low. Individual attributes can be weighted differently or subjected to processes such as normalization. Groups of attributes, including all of the attributes in the feature vector, can be normalized with respect to one another, which helps ensure that all attributes contribute equally to clustering regardless of their original scale.

In this example, the number of clusters, k, can be set to two, since it is desired to cluster data into a group representing satisfaction and a group representing dissatisfaction.

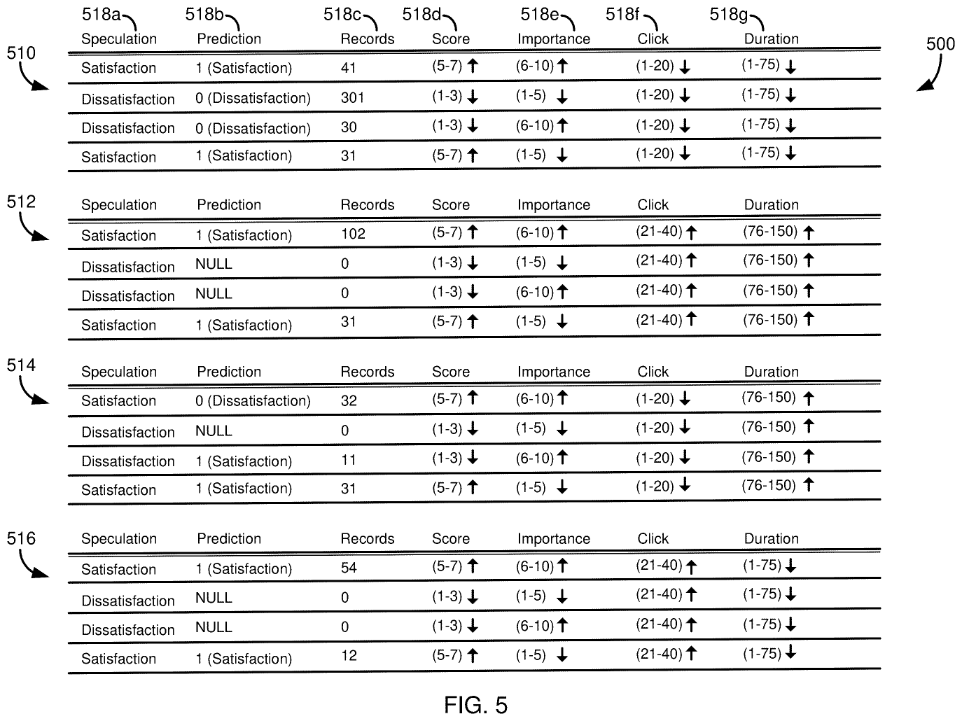

Example analysis results 500 are presented in FIG. 5, providing values for the variables identified above. In this case, it can be seen that the analysis results 500 are based on clustering of 676 use records.

In the results 500, values for attributes of columns 518d-518g have the format of (x-y), where x and y represent a range of values for a particular evaluation attribute. Column 518a provides an indication of whether a developer or other individual might speculate that a particular set of attribute values (row of the results 500) would be associated with overall satisfaction or dissatisfaction. In practice, obtaining a speculation is optional. The information about speculations is provided to help describe how disclosed techniques can provide information that might be counterintuitive or unexpected, demonstrated how disclosed technologies can facilitate software development.

Column 518b provides a prediction as a result of using disclosed techniques, such as an indication of whether a particular row (set of attribute values) is associated with satisfaction or dissatisfaction. Column 518c indicates a number of records in an overall set of records that contained the set of values for a particular row of the results 500.

Score, column 518d, represents a subjective evaluation score from a questionnaire, while importance, column 518e, refers to user-reported evaluation of the importance of the relevant software functionality. Clicks, column 518f, represents a number of clicks in a user session, while duration, column 518g, represents the duration of the user session.

FIG. 5 illustrates values being binned, such as where scores that indicate satisfaction (5-7) or dissatisfaction (1-3) are placed in bins that are associated with satisfaction or dissatisfaction. Similarly, values of relatively low duration are placed in one bin (1-75) while values indicating relatively higher duration are in another bin (76-150). The values shown in individual records of the results 500 for a particular prediction can be associated with indicators (the up or down arrows) providing an indication of whether a particular value, or value bin, is positively or negatively correlated with a particular result (clustering result).

In FIG. 5, the results 500 are divided into groups 510, 512, 514, 516, where the values of click and duration (columns 518f and 518g) are used to form the groups, and where the group 510 has fewer clicks and shorter duration, group 512 has high click values and longer duration, group 514 has low values for the number of clicks and longer duration, and group 516 has a higher number of clicks but a shorter duration.

Regarding the speculation values in column 518z, it can be seen that if the subjective evaluation score provided by users is high (values 5-7, representing user-reported satisfaction), the importance is high (6-10), the number of clicks is low (1-20), and the duration is short (1-75), then the speculation is that the user is satisfied. The same result is speculated using the same value ranges for subjective evaluation score and importance, where the number of clicks is high (21-40) and the duration is longer (76-150).

When the importance of the functionality is high (6-10) but the user subjective evaluation of satisfaction is low (1-3), the speculation is that the functionality is identified as a candidate for improvement both when the number of clicks is high (21-40) and the duration is high (76-150), and when the number of clicks is low (1-20) and the duration is shorter (1-75). Similarly, the speculation is that users are satisfied with functionality if the importance of the functionality is low (1-5) and the user satisfaction is high (5-7), regardless of whether the number of clicks is high or low.

The speculations above can be based on considering both the subjective and objective attributes together, but without being correlated as with the disclosed techniques. The prediction of the column 518b, based on the clustering, can identify scenarios where the prediction and the speculation do not match. In turn, this can provide insights as to how subjective and objective values influence one another, or where attributes that seem objectively good are in fact associated with dissatisfaction as a clustering or result, where attributes that seem objectively bad are associated with satisfaction, or where values for subjective attributes are not consistent with the clustering prediction.

Looking at the results 500, the predictions generally match the speculation. However, the predictions uncover two scenarios that can represent counterintuitive results. When the importance of the functionality is high (6-10), the user subjective evaluation of satisfaction is high (5-7), but the number of clicks is low (1-20) and the duration is long (76-150), the prediction from the clustering is that the user is dissatisfied. This is a counterintuitive result as the speculation is that the user is satisfied. This suggests that despite the high importance and high user satisfaction score, the low number of clicks combined with a long duration could indicate a problem with the functionality that leads to dissatisfaction/areas in which the software functionality could be improved, even if user's do not subjectively rate the software functionality poorly.

Similarly, when the importance of the functionality is high (6-10), the user subjective evaluation of satisfaction is low (1-3), the number of clicks is high (21-40) and the duration is short (1-75), the prediction from the clustering is that the user is satisfied. This is another counterintuitive result, as the speculation is that the user is dissatisfied. This suggests that despite the low user satisfaction score and high importance, the high number of clicks combined with a short duration could indicate that the users find value in the software despite the subjective dissatisfaction reported. This could indicate, for example, that users are unsatisfied with the visual appeal of the user interface, even if they are able to use it effectively.

Disclosed techniques can provide additional analysis to provide insights into how subjective and objective attributes can contribute to a clustering result, which can also provide insights into what issues should be prioritized for improvement, and how that improvement might be accomplished. For example, additional statistical methods can be used to provide more granular insights into how objective and subjective attributes might influence one another and how these attributes contribute to the predicted results of satisfaction or dissatisfaction.

Regression analysis can be used to examine the relationship between two or more variables (here, attributes, or a prediction) of interest. In the context of the disclosed techniques, the dependent variable could be the prediction of satisfaction or dissatisfaction, while the independent variables could be the various subjective and objective attributes. By using regression analysis, it is possible to quantitatively understand the impact of changes in independent variables on the dependent variable—the impact of changes in the evaluation attributes on the prediction.

In simple linear regression, there is a dependent variable Y and one independent variable X. The relationship between Y and X is expressed as:

$$Y = {β}_{0} + {β}_{1} X + ϵ$$

Here, Y is the dependent variable to be predicted, X is the independent variable used to make the prediction, β₀ is the y-intercept, β₁ is the slope of the line (i.e., the effect of X on Y), and ε is the error term.

Multiple regression can be used when there more than one independent variable:

$$Y = {β}_{0} + {β}_{1} {X}_{1} + {β}_{2} {X}_{2} + … {β}_{n} {X}_{n} + ϵ$$

Each β coefficient represents the change in the average value of Y given a one-unit change in the corresponding independent variable, holding all other independent variables constant.

Logistic regression is a type of regression analysis used when the dependent variable is binary, like the satisfaction/dissatisfaction prediction using the disclosed clustering technique. It can be used to understand how different attributes contribute to satisfaction or dissatisfaction. For example, the results of logistic regression could reveal that a high number of clicks is associated with dissatisfaction, even if the user satisfaction score is high. This provides valuable information for developers looking to improve the software.

Interaction effects occur when the effect of one variable depends on the value of another variable. Interaction effects are common in regression analysis and logistic regression and can be included in the model by creating new variables that are the product of the original variables. In the context of the disclosed techniques, an interaction effect might exist between the number of clicks and the duration of use. For example, a high number of clicks might be associated with satisfaction when the duration of use is short, but with dissatisfaction when the duration is long.

Attribute contributions and interactions can also be explored using techniques such as SHAP (SHapley Additive explanations) and LIME (Local Interpretable Model-agnostic Explanations). SHAP values are a unified measure of attribute importance that comes from cooperative game theory. The values provide an explanation for the output of any machine learning model by attributing the prediction of each instance to its attributes. In the context of the disclosed techniques, SHAP values can be used to quantify the contribution of each attribute, such as the number of clicks, duration of use, user satisfaction score, and importance of the function, to the predicted user satisfaction or dissatisfaction. For example, a high SHAP value for the number of clicks would indicate that this attribute has a strong influence on the prediction.

SHAP values can be used to identify interactions between attributes. For instance, consider two attributes: the number of clicks and the duration of use. If these two attributes interact, it means that the effect of the number of clicks on user satisfaction depends on the value of the duration of use, or vice versa. A high number of clicks might be associated with satisfaction when the duration of use is short, but with dissatisfaction when the duration is long. When calculating the SHAP value for the number of clicks, it considers all possible values of the duration of use and averages the effects. This gives a more accurate measure of the importance of the number of clicks, taking into account its interaction with the duration of use.

LIME is a technique for explaining the predictions of any machine learning model by approximating it locally with an interpretable model. It can help to understand how each attribute affects the prediction in individual instances. In the disclosed techniques, LIME could be used to understand why certain records are classified into the satisfaction or dissatisfaction cluster. For example, a LIME analysis may reveal that a long duration of use is the main reason for a record being classified into the dissatisfaction cluster, even if the user satisfaction score is high.

Principal component analysis (PCA) can be used to emphasize variation and bring out strong patterns in a dataset. It is often used to make data easy to explore and visualize. PCA involves calculating the eigenvalues and eigenvectors of the data covariance matrix, which forms the basis of the principal components. These components are a new set of variables that are linear combinations of the original variables. The first principal component accounts for the largest possible variance in the data, the second principal component accounts for the second largest variance, and so on.

In the context of the disclosed techniques, PCA could be used to reduce the dimensionality of the data while preserving the relationships among the variables. This can be particularly useful if there are a large number of subjective and objective attributes. The principal components could then be used in the clustering process, potentially revealing new insights about how attributes are contributing the prediction of satisfaction or dissatisfaction.

In a scenario with a large number of subjective and objective attributes, some of these attributes might be highly correlated, such as the number of clicks and the duration of use. This can make it difficult to interpret the results of the clustering process. By applying PCA, the dimensionality of the data is reduced while preserving the relationships among the variables. Instead of looking at each subjective and objective attribute separately, the principal components can be analyzed. For example, the first principal component might represent a combination of a high number of clicks and a long duration of use, while the second principal component might represent a combination of a high user satisfaction score and a high importance of the function. By reducing the number of components, it can be easier to identify insights that might have been difficult to recognize with the results from the original large number of attributes.

Additional analysis can involve decision trees or random forest models. Decision trees are a type of model used for both classification and regression. A tree-like model of decisions is created based on the variables in the data. For example, using the results 500, a decision tree could be used to predict user satisfaction based on the various subjective and objective attributes. The top of the tree (the root) represents the most significant decision factor, with branches leading to additional decisions or the final prediction (the leaves of the tree). Decision trees are particularly useful because they are easy to understand and interpret.

Random forest models are an extension of decision trees. They work by creating a “forest” of decision trees, each built on a random subset of the data, and averaging their predictions. This helps to improve the model's accuracy and control overfitting.

While clustering techniques have been described, other types of analysis can be used to obtain a prediction. For example, a classifier, such as using a neural network, can be trained using attribute vectors and known “correct” classifications (which could initially come from the above-described clustering technique). In addition to getting a classification/prediction from the trained model, techniques such as SHAP and LIME can be used to determine how particular attributes influence a classification result.

### Example 8—Example Prediction Process

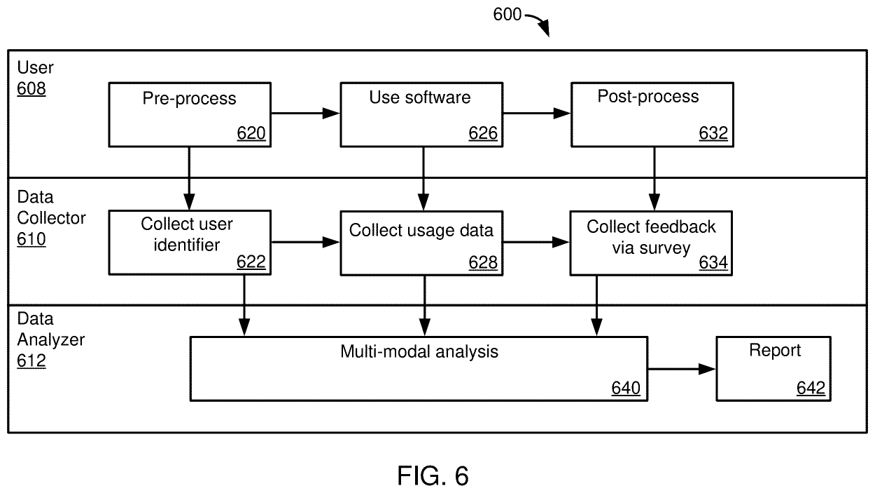

FIG. 6 is a swimlane diagram of a process 600 of performing a multi-modal software analysis according to a particular example of the disclosed techniques. The process 600 involves operations carried out by user 608, a data collector 610, and a data analyzer 612.

The user 608 begins interacting with software at 620 in a preprocessing step, which can involve launching an application/causing a user interface to be generated. As part of the processing at 620, the data collector 610 can collect information about a user, such as a user identifier. The user identifier can be useful, such as in associating actions of the user with the software with objective and subjective attributes.

The user 608 interacts with the software at 626. For example, the user can interact with one or more user interface elements. The data collector 610 collects usage data at 628 that occurs as part of use of the software at 626. As described, usage data can correspond to objective attributes that can be used to evaluate software, such as a number of clicks or a session duration.

At 632, the user 608 can undergo a post-process step. For example, the user 608 can be provided with a survey that is used to collect information for subjective evaluation attributes. The data collector 610 can be responsible for presenting the survey to the user 608 and collecting survey results.

The user identifier collected at 622, the usage data collected at 628, and the user survey results collected at 634 can undergo a multi-model analysis 640 carried out by the data analyzer 612. The multi-model analysis 64—can include an analysis that looks at subjective and objective attribute together to gain insights into how software is functioning and users' perceptions of the software, rather than separately considering them. For example, the multi-modal analysis 640 can include the clustering operations described in Example 8 that provide a prediction, as well as results of other techniques such as regression analysis.

The multi-modal analysis 640 results in a report 642. Users can review the report to gain an understanding of how objective and subjective attributes may be contributing to a prediction of whether use of the software, such as over multiple sessions of users that carryout the operations shown for the user 608, represents a scenario where users are satisfied or dissatisfied. The report 642 can include information in the format shown in FIG. 5, or in another format. After users review the report 642, they can better determine what software features to improve, as well as gaining insights into how the improvement might be achieved. For example, if a small number of clicks are reported over a relatively long time, this can indicate that the user interface is non-intuitive, and users are struggling to figure out how to perform a task.

### Example 9—Example Operations

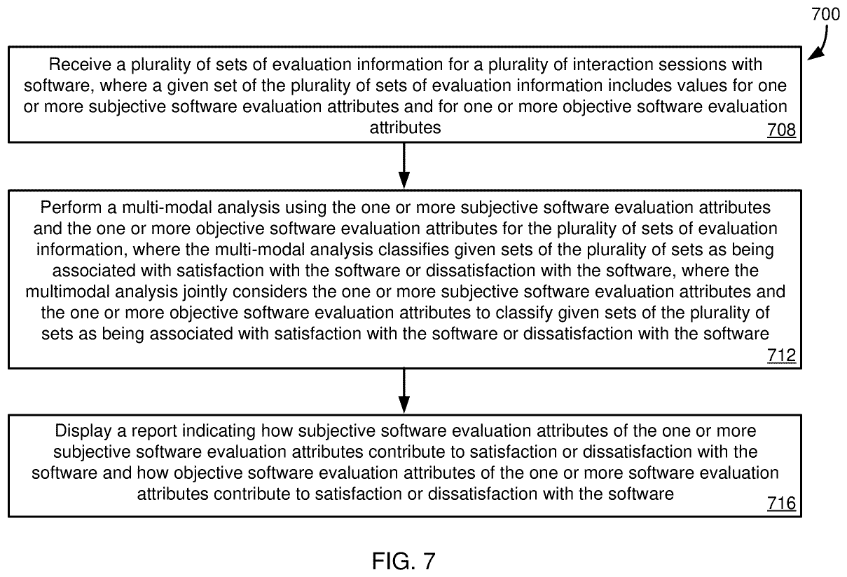

FIG. 7 is a flowchart of a process 700 for generating a report of how subjective and objective software evaluation attributes contribute to satisfaction or dissatisfaction with software based on a multi-modal analysis. At 708, a plurality of sets of evaluation information for a plurality of interaction sessions with software are received. A given set of the plurality of sets of evaluation information includes values for one or more subjective software evaluation attributes and for one or more objective software evaluation attributes.

At 712, a multi-modal analysis is performed using the one or more subjective software evaluation attributes and the one or more objective software evaluation attributes for the plurality of sets of evaluation information. The multi-modal analysis classifies given sets of the plurality of sets as being associated with satisfaction with the software or dissatisfaction with the software. This analysis jointly considers the one or more subjective software evaluation attributes and the one or more objective software evaluation attributes to classify given sets of the plurality of sets as being associated with satisfaction with the software or dissatisfaction with the software.

The computing system displays a report at 716. The report indicates how subjective software evaluation attributes of the one or more subjective software evaluation attributes contribute to satisfaction or dissatisfaction with the software and how objective software evaluation attributes of the one or more software evaluation attributes contribute to satisfaction or dissatisfaction with the software.

### Example 10—Additional Examples

Example 1 is a computing system that includes at least one hardware processor and at least one memory coupled to the at least one hardware processor, the computing system executes instructions that cause the computing system to perform various operations. The operations include receiving a plurality of sets of evaluation information for a plurality of interaction sessions with software. A given set of the plurality of sets of evaluation information includes values for one or more subjective software evaluation attributes and for one or more objective software evaluation attributes.

The operations also include performing a multi-modal analysis using the one or more subjective software evaluation attributes and the one or more objective software evaluation attributes for the plurality of sets of evaluation information. The multi-modal analysis classifies given sets of the plurality of sets as being associated with satisfaction with the software or dissatisfaction with the software. This analysis jointly considers the one or more subjective software evaluation attributes and the one or more objective software evaluation attributes to classify given sets of the plurality of sets as being associated with satisfaction with the software or dissatisfaction with the software.

The operations further include displaying a report. The report indicates how subjective software evaluation attributes of the one or more subjective software evaluation attributes contribute to satisfaction or dissatisfaction with the software and how objective software evaluation attributes of the one or more software evaluation attributes contribute to satisfaction or dissatisfaction with the software.

Example 2 is the computing system of Example 1, where the operations further include, during respective interactions sessions with the software, automatically capturing the values for at least a portion of the one or more objective software evaluation attributes.

Example 3 is the computing system of Example 2, where automatically capturing the values for at least a portion of the one or more objective software evaluation attributes includes recording a number of actions performed by a user through a user interface during an interaction session of the plurality of interaction sessions.

Example 4 is the computing system of Example 2 or Example 3, where automatically capturing the values for at least a portion of the one or more objective software evaluation attributes includes determining a duration of an interaction session of the plurality of interaction sessions.

Example 5 is the computing system of any of Examples 1-4, where the operations further include, during respective interaction sessions of the plurality of interaction sessions, displaying a survey on a user interface, the user interface displaying one or more questions; receiving a response to a question of the one or more questions through the user interface; and storing the response as a value of a subjective software evaluation attribute of the one or more subjective software evaluation attributes in association with an identifier of the interaction session.

Example 6 is the computing system of Example 5, where the subjective software evaluation attribute is a value indicating a level of satisfaction with the software.

Example 7 is the computing system of Example 5, where the subjective software evaluation attribute is a value indicating a level of importance of the software.

Example 8 is the computing system of any of Examples 1-7, where performing the multi-modal analysis includes performing clustering of the plurality of sets of evaluation information using feature vectors that include values for the one or more subjective software evaluation attributes and the one or more objective software evaluation attributes.

Example 9 is the computing system of Example 8, where the clustering is k-means clustering.

Example 10 is the computing system of Example 9, where k is equal to two and one cluster represents satisfaction with the software and one cluster represents dissatisfaction with software.

Example 11 is the computing system of any of Examples 8-10, where the operations further include determining respective relative contributions to a clustering result for at least a portion of the one or more subjective software evaluation attributes or at least a portion of the one or more objective software evaluation attributes.

Example 12 is the computing system of any of Examples 8-11, where the operations further include determining how interactions between two or more software evaluation attributes of the one or more subjective software evaluation attributes or the one or more objective software evaluation attributes contribute to a clustering result.

Example 13 is the computing system of any of Examples 1-12, where the report indicates that a set of values for the one or more subjective software evaluation attributes and the one or more objective software evaluation attributes is associated with dissatisfaction. The operations further include, in response to the displaying the report, receiving a modification to code of the software.

Example 14 is the computing system of any of Examples 1-13, where performing the multi-modal analysis includes binning values in at least one attribute of the one or more subjective software evaluation attributes or the one or more objective software evaluation attributes.

Example 15 is the computing system of Example 14, where the report provides results using bins resulting from the binning values.

Example 16 is a method, implemented in a computing system comprising at least one hardware processor and at least one memory coupled to the at least one hardware processor. The method includes the operations of Example 1.

Example 17 is the method of Example 16, where performing the multi-modal analysis includes performing clustering of the plurality of sets of evaluation information using feature vectors that include values for the one or more subjective software evaluation attributes and the one or more objective software evaluation attributes.

Example 18 is the method of Example 17, where the report indicates that a set of values for the one or more subjective software evaluation attributes and the one or more objective software evaluation attributes is associated with dissatisfaction. The method further includes, in response to the displaying the report, receiving a modification to code of the software.

Example 19 is one or more computer-readable storage media comprising computer-executable instructions that, when executed by a computing system comprising at least one hardware processor and at least one memory coupled to the at least one hardware processor, cause the computing system to perform the operations of Example 1.

Example 20 is the one or more computer-readable storage media of Example 19, where performing the multi-modal analysis includes performing clustering of the plurality of sets of evaluation information using feature vectors that include values for the one or more subjective software evaluation attributes and the one or more objective software evaluation attributes. The computer-readable storage media further includes computer-executable instructions that, when executed by the computing system, cause the computing system to, in response to the displaying the report, receive a modification to code of the software.

### Example 11—Computing Systems

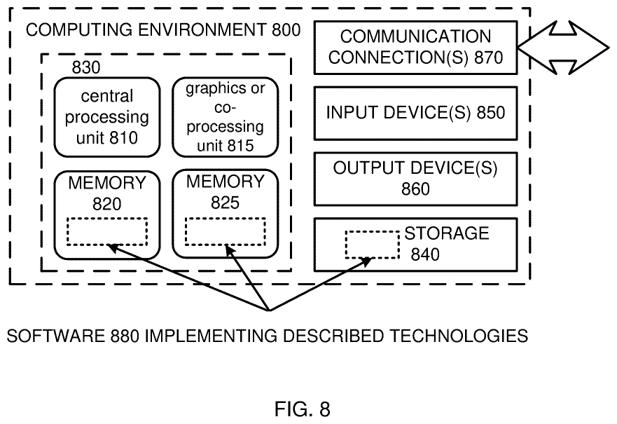

FIG. 8 depicts a generalized example of a suitable computing system 800 in which the described innovations may be implemented. The computing system 800 is not intended to suggest any limitation as to scope of use or functionality of the present disclosure, as the innovations may be implemented in diverse general-purpose or special-purpose computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions, such as for implementing the techniques described in Examples 1-9. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s) 810, 815. The memory 820, 825 stores software 880 implementing one or more innovations described herein, in the form of computer-executable instructions suitable for execution by the processing unit(s) 810, 815.

A computing system 800 may have additional features. For example, the computing system 800 includes storage 840, one or more input devices 850, one or more output devices 860, and one or more communication connections 870. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800. In some cases, the operating system can manage, or assist in managing, query language execution threads or job execution threads.

The tangible storage 840 may be removable or non-removable, and includes magnetic disks, magnetic tapes or cassettes, CD-ROMs, DVDs, or any other medium which can be used to store information in a non-transitory way and which can be accessed within the computing system 800. The storage 840 stores instructions for the software 820 implementing one or more innovations described herein.

The input device(s) 850 may be a touch input device such as a keyboard, mouse, pen, or trackball, a voice input device, a scanning device, or another device that provides input to the computing system 800. The output device(s) 860 may be a display, printer, speaker, CD-writer, or another device that provides output from the computing system 800.

The communication connection(s) 870 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 12—Cloud Computing Environment

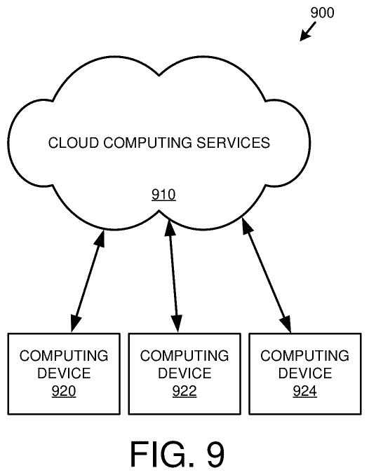

FIG. 9 depicts an example cloud computing environment 900 in which the described technologies can be implemented. The cloud computing environment 900 comprises cloud computing services 910. The cloud computing services 910 can comprise various types of cloud computing resources, such as computer servers, data storage repositories, networking resources, etc. The cloud computing services 910 can be centrally located (e.g., provided by a data center of a business or organization) or distributed (e.g., provided by various computing resources located at different locations, such as different data centers and/or located in different cities or countries).

The cloud computing services 910 are utilized by various types of computing devices (e.g., client computing devices), such as computing devices 920, 922, and 924. For example, the computing devices (e.g., 920, 922, and 924) can be computers (e.g., desktop or laptop computers), mobile devices (e.g., tablet computers or smart phones), or other types of computing devices. For example, the computing devices (e.g., 920, 922, and 924) can utilize the cloud computing services 910 to perform computing operators (e.g., data processing, data storage, and the like).

### Example 13—Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 8, computer-readable storage media include memory 820 and 825, and storage 840. The term computer-readable storage media does not include signals and carrier waves. In addition, the term computer-readable storage media does not include communication connections (e.g., 870).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one hardware processor;
at least one memory coupled to the at least one hardware processor; and
one or more computer-readable storage media comprising computer-executable instructions that, when executed, cause the computing system to perform operations comprising:
receiving a plurality of sets of evaluation information for a plurality of interaction sessions with software, wherein a given set of the plurality of sets of evaluation information comprises values for one or more subjective software evaluation attributes and for one or more objective software evaluation attributes;
performing a multi-modal analysis using the one or more subjective software evaluation attributes and the one or more objective software evaluation attributes for the plurality of sets of evaluation information, wherein the multi-modal analysis classifies given sets of the plurality of sets as being associated with satisfaction with the software or dissatisfaction with the software, wherein the multimodal analysis jointly considers the one or more subjective software evaluation attributes and the one or more objective software evaluation attributes to classify given sets of the plurality of sets as being associated with satisfaction with the software or dissatisfaction with the software; and
displaying a report indicating how subjective software evaluation attributes of the one or more subjective software evaluation attributes contribute to satisfaction or dissatisfaction with the software and how objective software evaluation attributes of the one or more software evaluation attributes contribute to satisfaction or dissatisfaction with the software.

2. The computing system of claim 1, the operations further comprising:
during respective interactions sessions with the software, automatically capturing the values for at least a portion of the one or more objective software evaluation attributes.

3. The computing system of claim 2, wherein automatically capturing the values for at least a portion of the one or more objective software evaluation attributes comprises recording a number of actions performed by a user through a user interface during an interaction session of the plurality of interaction sessions.

4. The computing system of claim 2, wherein automatically capturing the values for at least a portion of the one or more objective software evaluation attributes comprises determining a duration of an interaction session of the plurality of interaction sessions.

5. The computing system of claim 1, the operations further comprising, during respective interaction sessions of the plurality of interaction sessions:
displaying a survey on a user interface, the user interface displaying one or more questions;
receiving a response to a question of the one or more questions through the user interface; and
storing the response as a value of a subjective software evaluation attribute of the one or more subjective software evaluation attributes in association with an identifier of the interaction session.

6. The computing system of claim 5, wherein the subjective software evaluation attribute is a value indicating a level of satisfaction with the software.

7. The computing system of claim 5, wherein the subjective software evaluation attribute is a value indicating a level of importance of the software.

8. The computing system of claim 1, wherein performing the multi-modal analysis comprises performing clustering of the plurality of sets of evaluation information using feature vectors comprising values for the one or more subjective software evaluation attributes and the one or more objective software evaluation attributes.

9. The computing system of claim 8, wherein the clustering is k-means clustering.

10. The computing system of claim 9, wherein k is equal to two and one cluster represents satisfaction with the software and one cluster represents dissatisfaction with software.

11. The computing system of claim 8, the operations further comprising:
determining respective relative contributions to a clustering result for at least a portion of the one or more subjective software evaluation attributes or at least a portion of the one or more objective software evaluation attributes.

12. The computing system of claim 8, the operations further comprising:
determining how interactions between two or more software evaluation attributes of the one or more subjective software evaluation attributes or the one or more objective software evaluation attributes contribute to a clustering result.

13. The computing system of claim 1, wherein the report indicates that a set of values for the one or more subjective software evaluation attributes and the one or more objective software evaluation attributes is associated with dissatisfaction, the operations further comprising:
in response to the displaying the report, receiving a modification to code of the software.

14. The computing system of claim 1, wherein the performing the multi-modal analysis comprising binning values in at least one attribute of the one or more subjective software evaluation attributes or the one or more objective software evaluation attributes.

15. The computing system of claim 14, wherein the report provides results using bins resulting from the binning values.

16. A method, implemented in a computing system comprising at least one hardware processor and at least one memory coupled to the at least one hardware processor, the method comprising:
receiving a plurality of sets of evaluation information for a plurality of interaction sessions with software, wherein a given set of the plurality of sets of evaluation information comprises values for one or more subjective software evaluation attributes and for one or more objective software evaluation attributes;
performing a multi-modal analysis using the one or more subjective software evaluation attributes and the one or more objective software evaluation attributes for the plurality of sets of evaluation information, wherein the multi-modal analysis classifies given sets of the plurality of sets as being associated with satisfaction with the software or dissatisfaction with the software, wherein the multimodal analysis jointly considers the one or more subjective software evaluation attributes and the one or more objective software evaluation attributes to classify given sets of the plurality of sets as being associated with satisfaction with the software or dissatisfaction with the software; and
displaying a report indicating how subjective software evaluation attributes of the one or more subjective software evaluation attributes contribute to satisfaction or dissatisfaction with the software and how objective software evaluation attributes of the one or more software evaluation attributes contribute to satisfaction or dissatisfaction with the software.

17. The method of claim 16, wherein performing the multi-modal analysis comprising performing clustering of the plurality of sets of evaluation information using feature vectors comprising values for the one or more subjective software evaluation attributes and the one or more objective software evaluation attributes.

18. The method of claim 17, wherein the report indicates that a set of values for the one or more subjective software evaluation attributes and the one or more objective software evaluation attributes is associated with dissatisfaction, the method further comprising:
in response to the displaying the report, receiving a modification to code of the software.

19. One or more computer-readable storage media comprising:
computer-executable instructions that, when executed by a computing system comprising at least one hardware processor and at least one memory coupled to the at least one hardware processor, cause the computing system to receive a plurality of sets of evaluation information for a plurality of interaction sessions with software, wherein a given set of the plurality of sets of evaluation information comprises values for one or more subjective software evaluation attributes and for one or more objective software evaluation attributes;
computer-executable instructions that, when executed by the computing system, cause the computing system to perform a multi-modal analysis using the one or more subjective software evaluation attributes and the one or more objective software evaluation attributes for the plurality of sets of evaluation information, wherein the multi-modal analysis classifies given sets of the plurality of sets as being associated with satisfaction with the software or dissatisfaction with the software, wherein the multimodal analysis jointly considers the one or more subjective software evaluation attributes and the one or more objective software evaluation attributes to classify given sets of the plurality of sets as being associated with satisfaction with the software or dissatisfaction with the software; and
computer-executable instructions that, when executed by the computing system, cause the computing system to display a report indicating how subjective software evaluation attributes of the one or more subjective software evaluation attributes contribute to satisfaction or dissatisfaction with the software and how objective software evaluation attributes of the one or more software evaluation attributes contribute to satisfaction or dissatisfaction with the software.

20. The one or more computer-readable storage media of claim 19, wherein performing the multi-modal analysis comprises performing clustering of the plurality of sets of evaluation information using feature vectors comprising values for the one or more subjective software evaluation attributes and the one or more objective software evaluation attributes, further comprising:
computer-executable instructions that, when executed by the computing system, cause the computing system to, in response to the displaying the report, receive a modification to code of the software.
